(19) United States
(12) Patent Application Publication
(10) Pub. No.: US 2024/0281872 A1
(43) Pub. Date: Aug. 22, 2024

(54) PRODUCT DISPLAY METHOD AND DEVICE

(71) Applicant: Beijing Bytedance Network Technology Co., Ltd., Beijing (CN)

(72) Inventors: Chen CHEN, Beijing (CN); Jing CUI, Beijing (CN); Hanfei WU, Beijing (CN); Jingjin YUAN, Beijing (CN)

(21) Appl. No.: 18/571,544

(22) PCT Filed: Jul. 15, 2022
(86) PCT No.: PCT/CN2022/106114

§ 371 Date: Dec. 18, 2023

(30) Foreign Application Priority Data
Jul. 16, 2021 (CN) 202110808383.5

(51) Int. Cl. G06Q 30/0601; H04N 21/2187

(52) U.S. Cl. CPC G06Q 30/0641; H04N 21/2187

(57) ABSTRACT

A product display method and device are provided in embodiments of the disclosure is provided in the disclosure, which relates to the technical field of computer processing. The method includes: obtaining, in a first application, at least one product object information corresponding to at least one live room; in response to a display policy being satisfied, displaying a second interface in a first interface of the first application, the second interface including information of the live room and the product object information; and in response to detecting a first trigger signal for the second interface, displaying a detailed information browsing interface corresponding to the product object information, and/or displaying a live room viewing interface, the livestreaming viewing interface including the product object information.

### CROSS-REFERENCE

This disclosure claims priority to Chinese patent application No. 202110808383.5 filed on Jul. 16, 2021, entitled “Product Display Method and Device”, the contents of which are incorporated herein by reference.

### FIELD

Embodiments of this disclosure relate to the technical field of computer processing, and more particularly to a product display method and device, an electronic device, a storage medium, a computer program product, and a computer program.

### BACKGROUND

With increasingly powerful functions of electronic devices, various applications can be executed on the electronic devices to enable users to access various services through various applications. A commonly used application is a livestreaming application, through which users can enter a live room to watch livestreaming. With widespread use of livestreaming applications, goods can be livestreamed in the live room, and can be purchased by the users in the live room.

### SUMMARY

A product (e.g., merchandise) display method and device, an electronic device, a storage medium, a computer program product, and a computer program are provided in embodiments of this disclosure, which can enable users not being watching livestreaming to purchase goods livestreamed in a live room.

In a first aspect, a product display method is provided in the disclosure, which includes:

Obtaining, in a first application, at least one product object information corresponding to at least one live room:
In response to a display policy being satisfied, displaying a second interface in a first interface of the first application, the second interface including information of the live room and the product object information;
In response to detecting a first trigger signal for the second interface, displaying a detailed information browsing interface corresponding to the product object information, and/or displaying a live room viewing interface, the livestreaming viewing interface including the product object information.

In a second aspect, a product display apparatus is provided in an embodiment of the disclosure, which includes:
A product object information acquisition module configured for obtaining product object information corresponding to at least one live room in a first application;
A first display module configured for, in response to satisfying a display policy, displaying a second interface in a first interface of the first application, the second interface including information of the live room and the product object information; and
A second display module configured for, in response to detecting a first trigger signal for the second interface, displaying a detailed information browsing interface corresponding to the product object information, and/or displaying a live room viewing interface, the livestreaming viewing interface including the product object information.

In a third aspect, an electronic device is provided in an embodiment of the disclosure, which includes: at least one processor and a memory.

The memory is configured for storing computer-executed instructions.

The at least one processor is configured for executing the computer-executed instructions stored in the memory, causing the electronic device to implement the method as described in the first aspect.

In a fourth aspect, a computer-readable storage medium is provided in an embodiment of the present disclosure, with computer-executed instructions stored therein, which, when executed by a computing device, causes the computing device to implement the method as described in the first aspect.

In a fifth aspect, a computer program product is provided in an embodiment of the present disclosure, which includes a computer program. The computer program is executed by a processor for implementing the method as described in the first aspect.

In a sixth aspect, a computer program is provided in an embodiment of the present disclosure. The computer program is executed by a processor for implementing the method as described in the first aspect.

### BRIEF DESCRIPTION OF THE DRAWINGS

In order to explain technical schemes in this disclosure or related technologies more clearly, the drawings required in the description of the embodiments, or the related art will be briefly introduced below: obviously, the drawings in the following description are some of embodiments of the present disclosure, and other drawings can be obtained according to these drawings by those of ordinary skill in the art without paying creative labor.

FIG. 1 is a schematic diagram of a product purchase scenario to which the present disclosure can be applied;

FIG. 2 is a flowchart of steps of a product display method according to an embodiment of the disclosure:

FIG. 3 is a schematic diagram of a relationship between a first interface, a second interface, and a third interface according to an embodiment of the disclosure:

FIG. 4 is a block diagram of a product display device according to an embodiment of the disclosure; and

FIG. 5 and FIG. 6 are block diagrams of two electronic devices according to embodiments of the disclosure.

### DETAILED DESCRIPTION

In order to make the purposes, technical schemes, and advantages of embodiments of this disclosure clearer, the technical schemes in the embodiments of this disclosure will be described clearly and completely with reference to the drawings in the embodiments of this disclosure; and it is Obvious that the described embodiments are part of the embodiments of this disclosure, but not all of them. On a basis of the embodiments in this disclosure, all other embodiments obtained by the ordinary skilled in the art without any creative effort are within the protection scope of this disclosure.

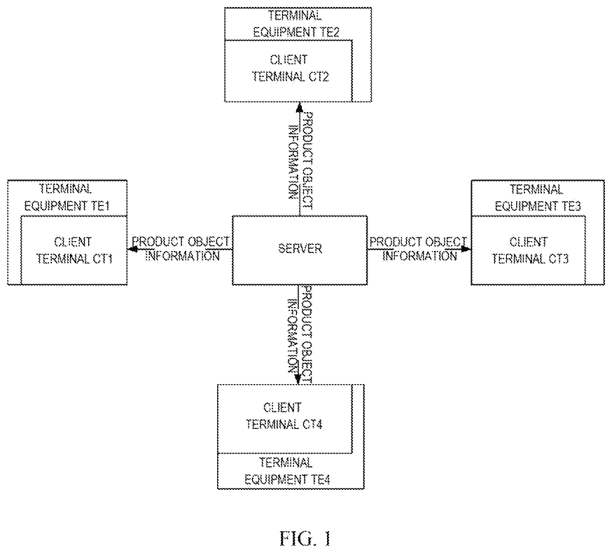

The embodiments of the disclosure can be applied to a product purchase scenario. FIG. 1 is a schematic diagram of a product purchase scenario to which the present disclosure can be applied. Referring to FIG. 1, the product purchase scenario involves terminal devices and a server, each of terminal devices is executed with a client which is configured to access the server. FIG. 1 schematically shows one server and four terminal devices TE1, TE2, TE3, and TE4, respectively running CT1, CT2, CT3, and CT4. CT1, CT2, CT3, and CT4 can all be connected to the server to obtain one or more product object information from the server. The user can select a product to be purchased from one or more products based on the product object information.

When the client and server are respectively a client and a server of the livestreaming application, the client can display a joined live room or the first interface, and the first interface is a first interface of a product store. When the live room is displayed on the client, live room data sent by the server to the client includes the product object information, and the user can select the product to be purchased based on the product object information. It can be seen that in the product purchase scenario, the user can purchase a product livestreamed in the live room while watching livestreaming. When the client displays the first interface, that is, the user is not watching the livestreaming, the user cannot purchase products livestreamed in the live room through the client.

In order to solve above problems, in the embodiments of the disclosure, a second interface can be displayed in the first interface, the second interface includes the product object information in the live room, so that the user not being watching the livestreaming can purchase products in the live room through the second interface.

Technical schemes of the present disclosure and manners in the technical schemes of the present disclosure to solve above technical problems will be described in detail in the following by way of specific embodiments. Specific embodiments in the following may be combined with each other, and same or similar concepts or processes may not be repeatedly described in some embodiments. The embodiments of the disclosure will be described in conjunction with the accompanying drawings in the following.

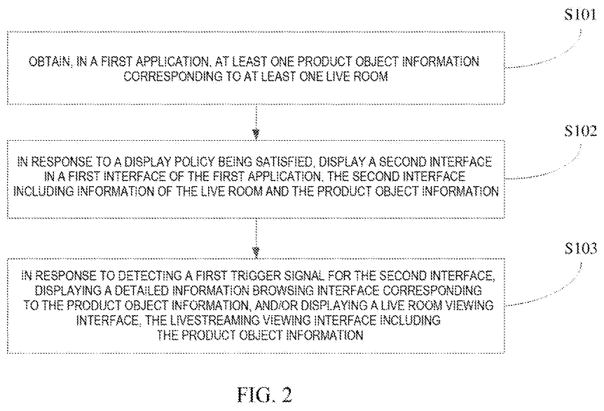

FIG. 2 is a flowchart of steps of a product display method according to an embodiment of the disclosure. The method shown in FIG. 2 can be applied in an electronic device. Referring to FIG. 2, the product display method includes following steps S101 to S103.

In step S101, at least one product object information corresponding to at least one live room is obtained in a first application.

The first application can be the livestreaming application described above.

The product object information can include but is not limited to: an image, a name, a size, a shape, and a color of a product. It can be understood that the at least one product object information can be information on all of products livestreamed in one live room, or information on all of products livestreamed in multiple live rooms.

The at least one product object information corresponds to information of a product being sold in the live room.

Optionally, the at least one live room satisfies the at least one live room satisfies at least one of following conditions: a number of followers of a host of the live room being greater than or equal to a second threshold, the host of the live room being in a front position in a host sequence arranged in a descending order of numbers of followers, a historical sale parameter of the host of the live room being greater than or equal to a third threshold, and the host of the live room being in a front position in a host sequence ranked in a descending order of historical sale parameters.

Specifically, the number of the followers of the host of the live room in the step S101 can be a number of persons following the host. The number of the followers of the host of the live room in the step S101 being greater than or equal to the second threshold means that product object information in livestreaming of a host whose number of followers is greater than or equal to the second threshold is displayed in the second interface. Assuming that the satisfying the display policy refers that the number of followers of the host of the live room is greater than or equal to the second threshold, when the second interface is loaded after each start of the first application, the second interface is displayed if the number of the followers of the host of the live room in the step S101 is greater than or equal to the second threshold; and the second interface is not displayed if the number of the followers of the host of the live room in the step S101 is less than the second threshold.

The host of the live room being in the front position in the host sequence arranged in the descending order of numbers of followers in the step S101 means that product object information in livestreaming of top N hosts is displayed in the second interface. Assuming that the satisfying the display policy refers that the host of the live room is in the front position in the host sequence arranged in the descending order of numbers of followers, when the second interface is loaded after each start of the first application, the second interface is displayed if the host of the live room in the step S101 is in a front position in the host sequence arranged in the descending order of numbers of followers; and the second interface is not displayed if the host of the live room in the step S101 is in a back position in the host sequence arranged in the descending order of numbers of followers. The host sequence includes all of hosts in the first application, not only hosts in livestreaming obtained in the step S101, but also hosts not in livestreaming.

The historical sale parameter of the host of the live room in the step S101 can be a total historical sale volume or a historical sale volume per unit time. The historical sale parameter of the host of the live room in the step S101 being greater than or equal to the third threshold means that product object information of the in livestreaming of a host whose historical sale parameter is greater than or equal to the third threshold is displayed in the second interface. Assuming that the satisfying the display policy refers that the historical sale parameter of the host of the live room in the step S101 is greater than or equal to the third threshold, when the second interface is loaded after each start of the first application, the second interface is displayed if the historical sale parameter of the host of the live room in the step S101 is greater than or equal to the third threshold; and the second interface is not displayed if the historical sale parameter of the host of the live room in the step S101 is less than the third threshold.

The host of the live room in the step S101 being in the front position in the host sequence arranged in the descending order of historical sale parameters that means that product object information in livestreaming of top N hosts is displayed in the second interface. Assuming that the satisfying the display policy refers that the host of the live room in the step S101 is in the front position in the host sequence arranged in the descending order of historical sale parameters, when the second interface is loaded after each start of the first application, the second interface is displayed if the host of the live room in the step S101 is in a front position in the host sequence arranged in the descending order of historical sale parameters; and the second interface is not displayed if the host of the live room in the step S101 is in a back position in the host sequence arranged in the descending order of historical sale parameters. The host sequence includes all of hosts in the first application, not only hosts in livestreaming obtained in the step S101, but also hosts not in livestreaming.

Optionally, the at least one product object information satisfies the at least one product object information satisfies at least one of following conditions: a reference parameter corresponding to the product object information being greater than or equal to the first threshold, and the product object information being in a front position in a product object information sequence ranked in a descending order of reference parameters.

Specifically, a reference parameter corresponding to the product object information in the step S101 includes at least one of the following: a historical sale parameter of the product object information and a historical search parameter for the product object information. The historical sale parameters of the product object information can be a total historical sale volume of a product corresponding to the product object information, or a historical sale volume of the product corresponding to the product object information per unit time. The historical search parameter for the product object information can be a total number of historical searches for the product corresponding to the product object information, or a number of historical searches (also known as a search frequency) for the product corresponding to the product object information per unit time.

The reference parameter corresponding to the product object information in the step S101 being greater than or equal to the first threshold means that the product object information in livestreaming of a host whose reference parameter corresponding to the product object information in the step S101 is greater than or equal to the first threshold is displayed in the second interface. Assuming that the satisfying the display policy refers that the reference parameter corresponding to the product object information in the step S101 is greater than or equal to the first threshold, when the second interface is loaded after each start of the first application, the second interface is displayed if the reference parameter corresponding to the product object information in the step S101 is greater than or equal to the first threshold; and the second interface is not displayed if the reference parameter corresponding to the product object information in the step S101 is less than the first threshold.

The product object information in the step S101 being in the front position in the product object information sequence arranged in the descending order of reference parameters means that product object information in livestreaming of top N hosts is displayed in the second interface. Assuming that the satisfying the display policy refers that the product object information in the step S101 is in the front position in the product object information sequence arranged in the descending order of reference parameters, when the second interface is loaded after each start of the first application, the second interface is displayed if the product object information in the step S101 is in the front position in the product object information sequence arranged in the descending order of reference parameters; and the second interface is not displayed if the product object information in the step S101 is in a back position in the product object information sequence arranged in the descending order of reference parameters. The host sequence includes all of hosts in the first application, not only hosts in livestreaming obtained in the step S101, but also hosts not in livestreaming.

In step S102, a second interface is displayed in a first interface of the first application in response to satisfying a display policy, and the second interface includes information of the live room and the product object information.

The first interface can be a default interface after entering the first application, or it can be called a homepage of the first application. The information of the live room can include but is not limited to: a name of a host of the live room or an identifier of the host of the live room.

In the embodiments of the disclosure, the second interface can be displayed according to a dynamic display policy, i.e., the product object information and information of a corresponding live room are displayed dynamically. When the display policy is satisfied, the second interface is displayed; and when the display policy is not satisfied, the second interface is not displayed.

The satisfying the display policy may include at least one of the following: a number of terminating of the second interface being less than the first threshold, and a second trigger signal being received.

Correspondingly, not satisfying the display policy is determined based on the satisfying the display policy. For example, if the satisfying the display policy refers that the number of closings of the second interface is less than the first threshold, and the second trigger signal is received, not satisfying the display policy refers that the number of closings of the second interface is greater than the first threshold, or the second trigger signal is not received. If the satisfying the display policy refers that the number of closings of the second interface is less than the first threshold, the display policy not being satisfied refers that the number of closings of the second interface is greater than or equal to the first threshold.

The number of closings of the second interface described above is increased by 1 each time after the user closes the second interface once, so as to count the number of the user manually closing the second interface. Assuming that satisfying the display policy refers that the number of closings of the second interface is less than the first threshold, when the second interface is loaded after each start of the first application, the second interface is displayed if the number of closings of the second interface is less than the first threshold; and the second interface is not displayed if the number of closings of the second interface is greater than or equal to the first threshold. When the second interface is displayed, the user can click a closing control in the second interface to close the second interface. When the user closes the second interface, the number of closings can be increased by 1, and so on until the number of closings is greater than or equal to the first threshold when the first interface is loaded.

The second trigger signal being received refers that an operation instruction from the user on the first interface is received, for example, the user slides down the first interface. Assuming that the satisfying the display policy refers that the operation instruction from the user on the first interface is received, each time after start of the first application and loading of the first interface, the second interface is displayed if the second trigger signal is received, and the second interface is not displayed if the second trigger signal is not received.

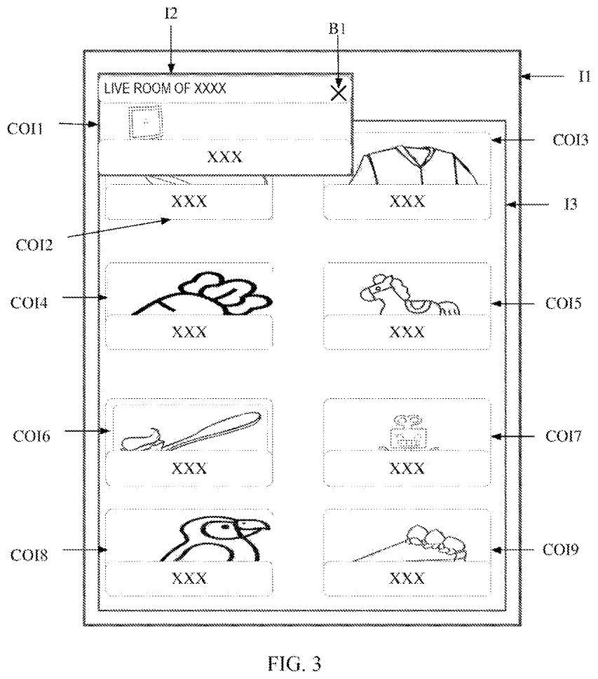

FIG. 3 is a schematic diagram of a relationship between a first interface, a second interface, and a third interface according to an embodiment of the disclosure. Referring to FIG. 3, the first interface I1 includes the second interface 12 and the third interface 13. The second interface 12 includes product object information COI1 and information “a live room of XXXX” of a live room corresponding to COI1. The third interface 13 includes product object information COI2 to COI9 of eight products. It can be understood that the product object information in the third interface and the product object information in the second interface can be of a same type or different types. For example, the product object information in the second interface can include a name and a picture of a product, and the product object information in the third interface can include a name, a picture, and a sale progress of a product.

As can be seen from FIG. 3, the second interface 12 is superimposed and displayed at an edge position on the first interface I1.

It should be noted that products of which product object information is displayed on the second interface at the same time are limited. For example, product object information of one product is displayed on the second interface 12 in FIG. 3. At this time, the product object information in the second interface is displayed in a switching way, product object information before switching is product object information of a product whose sale is ended, and product object information after switching is product object information of a product whose sale is not ended. That is to say, if the product object information obtained in the step S101 is for multiple products, product object information of one product can be randomly selected and displayed on the second interface. After the product is at the end of selling, the product object information of the product is no longer displayed on the second interface, but product object information of an unsold product is re-selected and displayed on the second interface. In this way, it is stopped until all of the products obtained in the step S101 are at the end of selling or the second interface is closed by the user.

Regarding the third interface described above, which includes discounted product object information, the third interface is a sub-interface of the first interface. In addition to the discounted product object information, the third interface further includes other product object information. That is to say, the third interface includes at least one discounted product object information and at least one other product object information, which are alternately arranged. For example, the product object information COI4 and COI8 in FIG. 3 can be discounted product object information, while COI2, COI3, COI5, COI6, COI7, and COI9 are all other product object information, and the other product object information is not information of a product in the live room.

Among them, the discounted product object information refers to information of a discounted or price-cut item. Of course, the discounted product object information is also information of products being livestreamed in the live room.

In the embodiments of the disclosure, the discounted product object information is inserted among other product object information according to a preset policy, e.g., every M pieces of other product object information are inserted with N pieces of discounted product object information. M, N, and an insertion position may be randomly selected or is fixed.

Optionally, the product object information in the second interface and/or the third interface may also include discount information of a product. The discount information can be a degree of discount, a degree of price reduction, etc.

Optionally, the product object information in the second interface and/or the third interface may further include a sale progress of a product. When a sold parameter of a product is greater than or equal to a fourth threshold and less than the fifth threshold, the sale progress is the sold parameter; and when the sold parameter of the product is greater than or equal to a fifth threshold, the sale progress is an unsold parameter.

It can be seen that the fourth threshold is less than the fifth threshold.

The sold parameter can be a quantity of a sold product or a sold ratio, and the sold ratio is a ratio of the quantity of the sold product to a total quantity.

Of course, when the sale progress is less than the fourth threshold, the sale progress may not be displayed, and when the sale progress is greater than the fourth threshold, the sale progress may be displayed.

In the embodiments of the disclosure, the sold parameter can be displayed when the sold parameter is greater than or equal to the fourth threshold value and less than the fifth threshold value, and the unsold parameter can be displayed when the sold parameter is greater than or equal to the fifth threshold value. In this way, users can be facilitated to accurately grasp a sale status of products, thereby ensuring that users purchase products in a timely manner.

Optionally, the product object information in the second interface and/or the third interface further includes a recommendation reason or information of a host corresponding to the product object information, and the recommendation reason includes at least one of the following: purchasing other products of a target host, rewarding the target host, and following the target host. The target host is a host to which a product corresponding to the product object information belongs.

It can be understood that products discounted in the live room may or may not be related to the user. When the user has purchased other products from the host to which the product belongs, or has rewarded the host to which the product belongs, or has followed the host to which the product belongs, it means that the product is related to the user. Otherwise, the product has nothing to do with the user.

When the product is not related to the user, information of a host to which the product belongs can be displayed, for example, a name of the host. The host to which the product belongs is a host livestreaming the item.

In practical applications, recommendation reasons and information of hosts are displayed in a decreasing order of priority of the following: purchasing other products of the target host, rewarding the target host, following the target host, and information of the host. That is to say: for a product, if the user has purchased other products livestreamed by the host to which the product belongs. “The host you have purchased” can be displayed, representing that a recommendation reason is purchasing other products of the target host. If the user has not purchased other products livestreamed by the host to which the product belongs but has rewarded the host to which the product belongs. “The host you have rewarded” can be displayed, representing that a recommendation reason is rewarding the target host. If the user has not purchased other products of livestreamed by the host to which the product belongs, and has not rewarded the host to which the product belongs, but the user has followed the host to which the product belongs. “The host you follow” can be displayed, representing that a recommendation reason is following the target host. If the user has not purchased any other products from the host livestreaming to which the product belongs, has not tipped the host to which the product belongs, and has not followed the host to which the product belongs, the name of the host can be displayed.

Optionally, the product object information in the second and/or third interfaces may include an image and text, and the text is superimposed and displayed on the image. As shown in FIG. 3, respective product object information COI1 to COI9 include an image and text, and the text is superimposed and displayed on the image. In this way, a sense of separation between the image and the text can be avoided, and the user can accurately determine that the image and the text are for a same item.

It should be noted that when the second interface only includes the product object information of one item, correspondence between the text and the image can be accurately determined, so that the text and the image in the product object information in the second interface can be located in different areas of the second interface without need for text to be superimposed and displayed on the image. That is to say, even if there is a sense of separation between the text and the image, it can be determined that the text and the image correspond to a same item.

In step S103, in response to detecting a first trigger signal for the second interface, a detailed information browsing interface corresponding to the product object information is displayed, and/or a live room viewing interface is displayed, the livestreaming viewing interface including the product object information.

The first trigger signal can be a user's click operation on any area in the second interface.

It can be understood that users can operate on the product object information in the livestreaming viewing interface so as to purchase a product corresponding to the product object information.

Of course, when the first trigger signal is received, the detailed information browsing interface corresponding to the product object information can also be displayed, so that the user can purchase the product corresponding to the product object information in this purchase interface.

Optionally, when the second interface is displayed in the first interface of the first application, the second interface is stopped to be displayed in the first interface of the first application in response to satisfying a stop display policy.

Specifically, the second interface can be exited from the first interface, for example, the second interface can be slid out of the first interface in a second direction. Correspondingly, when the second interface is displayed, the second interface can be slid into the first interface in a first direction. Of course, the first and second directions are two opposite directions, for example, the first direction is a direction from left to right, and the second direction is a direction from right to left.

The satisfying the stop display policy includes at least one of the following: receiving a terminating operation on the second interface, and products corresponding to the at least one product object information in the step S101 are all at the end of selling.

The closing operation on the second interface described above can be a clicking operation on a control B1 in FIG. 3. Being at the end of selling can include at least one of the following, the product being sold out, the product being off the market, and a specified end time of selling of the product being reached.

Corresponding to the product display method of the embodiment described above. FIG. 4 schematically shows a block diagram of a product display apparatus according to an embodiment of the disclosure. For convenience of explanation, only parts related to embodiments of the disclosure are shown. Referring to FIG. 4, the product display apparatus 200 includes: a product object information acquisition module 201, a first display module 202 and a second display module 203.

The product object information acquisition module 201 is configured for obtaining product object information corresponding to at least one live room in a first application.

The first display module 202 is configured for, in response to satisfying a display policy, displaying a second interface in a first interface of the first application, the second interface including information of the live room and the product object information.

The second display module 203 is configured for, in response to detecting a first trigger signal for the second interface, displaying a detailed information browsing interface corresponding to the product object information, and/or displaying a live room viewing interface, the livestreaming viewing interface including the product object information

Optionally, the satisfying the display policy includes at least one of the following: a number of terminating of the second interface being less than the first threshold, and a second trigger signal being received.

Optionally, the at least one live room satisfies the at least one live room satisfies at least one of following conditions: a number of followers of a host of the live room being greater than or equal to a second threshold, the host of the live room being in a front position in a host sequence arranged in a descending order of numbers of followers, a historical sale parameter of the host of the live room being greater than or equal to a third threshold, and the host of the live room being in a front position in a host sequence ranked in a descending order of historical sale parameters.

Optionally, the at least one product object information satisfies the at least one product object information satisfies at least one of following conditions: a reference parameter corresponding to the product object information being greater than or equal to the first threshold, and the product object information being in a front position in a product object information sequence ranked in a descending order of reference parameters. The reference parameter includes at least one of the following: a historical sale parameter of the product object information and a historical search parameter for the product object information.

Optionally, the apparatus further includes:
a stop display module configured for ceasing displaying the second interface in the first interface of the first application in response to satisfying a stop display policy when the second interface is displayed in the first interface of the first application.

Optionally, the satisfying the stop display policy comprises at least one of the following: receiving a terminating operation on the second interface, and sale of products corresponding to the at least one product object information being ended.

Optionally, the second interface is superimposed and displayed at an edge position on the first interface.

Optionally, the product object information in the second interface is displayed in a switching way, product object information before switching is product object information of a product whose sale is ended, and product object information after switching is product object information of a product whose sale is not ended.

Optionally, the apparatus further includes:
a third display module configured for displaying a third interface in the first interface of the first application, the third interface being a sub-interface of the first interface, and the third interface comprising at least one discounted product object information and at least one other product object information, which are alternately arranged.

Optionally, the product object information further comprises discount information of a product.

Optionally, the product object information further comprises a sale progress of a product, when a sold parameter of a product is greater than or equal to a fourth threshold and less than the fifth threshold, the sale progress is the sold parameter; and when the sold parameter of the product is greater than or equal to a fifth threshold, the sale progress is an unsold parameter.

Optionally, the product object information further comprises a recommendation reason or information of a host corresponding to the product object information, and the recommendation reason comprises at least one of the following: having purchased other products of a target host, and following the target host, the target host being a host to which a product corresponding to the product object information belongs.

Optionally, the product object information includes an image and text, and the text is superimposed and displayed on the image.

The product display apparatus according to the embodiments of the disclosure can serve to implement technical schemes of the method embodiments shown in FIG. 2, with similar implementation principle and technical effects, which will not be repeatedly described herein.

FIG. 5 is a block diagram of an electronic device 600 according to an embodiment of the disclosure. The electronic device 600 includes a memory 602 and at least one processor 601. The memory 602 stores computer-executed instructions.

The at least one processor 601 executes computer-executed instructions stored in the memory 602, causing the electronic device 601 to implement the method in FIG. 2.

In addition, the electronic device may further include a receiver 603 for receiving information from other apparatuses or devices and forwarding it to the processor 601, and a transmitter 604 for transmitting information to other apparatuses or devices.

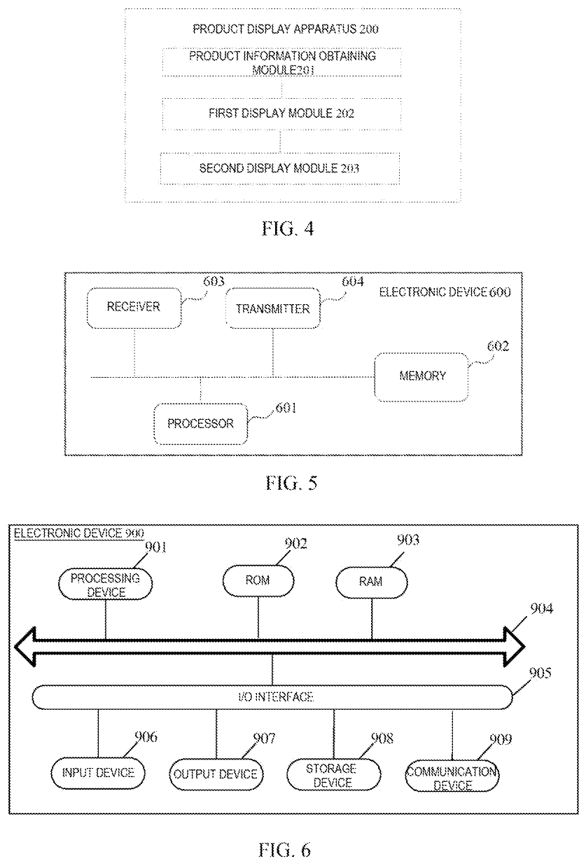

Furthermore, FIG. 6 is a schematic structural diagram of an electronic device 900 according to an embodiment of the present disclosure. The electronic device 900 can be a terminal device. The terminal device can include but is not limited to mobile terminals such as mobile phones, laptops, digital broadcast receivers, personal digital assistants (PDAs), portable android devices (PADs), portable multimedia players (PMPs), vehicle-mounted terminals (such as vehicle-mounted navigation terminals), and fixed terminals such as digital TVs, desktop computers, etc. The electronic device shown in FIG. 6 is only an example and should not limit functionality and scope of use of the present disclosure.

As shown in FIG. 6, the electronic device 900 may include a processing device (such as a central processor, a graphics processing unit, etc.) 901, which can perform various appropriate actions and processes according to a program stored in read only memory (ROM) 902 or a program loaded from a device 908 into a random access memory (RAM) 903. In RAM 903, various programs and data required for operations of the electronic device 900 are further stored. The processing device 901. ROM 902, and RAM 903 are connected to each other through a bus 904. An Input/output (I/O) interface 905 is also connected to the bus 904.

Typically, the following device can be connected to the I/O interface 905: an input device 906 including a touch screen, a touchpad, a keyboard, a mouse, a camera, a microphone, an accelerometer, a gyroscopes, etc.; an output device 907 including a liquid crystal displays (LCD), a speaker, a vibrator, etc.; a storage device 908 including a magnetic tape, a hard disk, etc.; and a communication device 909. The communication devices 909 can allow the electronic device 900 to communicate wirelessly or wirelessly with other devices to exchange data. Although FIG. 6 shows the electronic device 900 with various devices, it should be understood that it is not required to implement or have all of the devices shown. Alternatively, more, or fewer devices can be implemented or provided.

Particularly, according to embodiments of the present disclosure, the process described above with reference to the flowchart may be implemented as a computer software program. For example, an embodiment of the present disclosure includes a computer program product including a computer program carried on a computer readable medium, and the computer program contains program code for executing the method shown in the flowchart. In such an embodiment, the computer program may be downloaded and installed from a network via the communication apparatus 909, or installed from the storage apparatus 908, or installed from the ROM 902. When the computer program is executed by the processing apparatus 901, above-described functions defined in the method of the present disclosure are performed.

It should be noted that the above-mentioned computer-readable medium in this disclosure can be a computer-readable signal medium or a computer-readable storage medium or any combination of the above two. The computer-readable storage medium can be, for example, but not limited to, an electronic, magnetic, optical, electromagnetic, infrared, or semiconductor system, apparatus, or device, or any combination of the above. More specific examples of the computer-readable storage media may include, but are not limited to, electrical connections with one or more wires, portable computer disks, hard disks, random access memories (RAMs), read-only memories (ROMs), erasable programmable read-only memories (EPROMs), flash memories, optical fibers, portable compact disk read-only memories (CD-ROMs), optical storage devices, magnetic storage devices, or any suitable combination of the above. In this disclosure, the computer-readable storage medium can be any tangible medium containing or storing a program, which can be used by or in combination with an instruction execution system, apparatus, or device. In this disclosure, the computer-readable signal medium may include a data signal propagated in baseband or as a part of a carrier wave in which the computer-readable program code is carried. This propagated data signal can take various forms, including but not limited to an electromagnetic signal, an optical signal, or any suitable combination of the above. The computer-readable signal medium can also be any computer-readable medium other than a computer-readable storage medium, which can send, propagate or transmit a program for use by or in connection with an instruction execution system, apparatus, or device. The program code contained on the computer-readable medium can be transmitted with any suitable medium, including but not limited to: wires, optical cables, radio frequency (RF), etc., or any suitable combination thereof.

The computer-readable medium can be included in the electronic device, or it can exist separately without being assembled into the electronic device.

The computer-readable medium carries one or more programs, which, when executed by the electronic device, cause the electronic device to perform the method shown in the above embodiments.

Computer program code for performing operations of the present disclosure may be written in one or more programming languages or combinations thereof, including Object Oriented programming languages such as Java. Smalltalk. C++, as well as conventional procedural programming languages such as “C” or similar programming languages. The program code may be executed entirely on the user's computer, partially on the user's computer, as a standalone software package, partially on the user's computer and partially on a remote computer, or entirely on the remote computer or server. In the case of a remote computer, the remote computer may be connected to the user's computer via any type of network, including a local area network (LAN) or a wide area network (WAN), or may be connected to an external computer (e.g., via the Internet using an Internet service provider).

The flowcharts and block diagrams in the drawings illustrate the architecture, functions, and operations of possible implementations of systems, methods, and computer program products according to various embodiments of the present disclosure. In this regard, each block in the flowchart or block diagram may represent a module, a program segment or a part of code containing one or more executable instructions for implementing specified logical functions. It should also be noted that in some alternative implementations, the functions noted in the blocks may also occur in a different order from that noted in the drawings. For example, two blocks in succession may actually be executed in substantially parallel, or they may sometimes be executed in a reverse order, depending on the functions involved. It should also be noted that each block in the block diagrams and/or flowcharts, along with combinations of blocks in the block diagrams and/or flowcharts, can be implemented with dedicated hardware-based systems that perform specified functions or operations, or can be implemented with combinations of dedicated hardware and computer instructions.

A unit described in the embodiments of the disclosure may be implemented in software or in hardware. A name of the unit does not constitute limitation on the unit itself under certain circumstances, for example, the first acquisition unit may also be described as “a unit that acquires at least two Internet protocol addresses.”

The functions described above in this disclosure can be performed at least in part by one or more hardware logic components. For example, without limitation, exemplary types of hardware logic components that can be used include: a Field Programmable Gate Array (FPGA), an Application Specific Integrated Circuit (ASIC), an Application Specific Standard Product (ASSP), a System On Chip (SOC), a Complex Programmable Logic Device (CPLD), and so on.

In the context of the present disclosure, a machine-readable medium can be a tangible medium that can contain or store a program for use by or in connection with an instruction execution system, apparatus, or device. The machine-readable medium may be a machine-readable signal medium or a machine-readable storage medium. The machine-readable media can include, but are not limited to, electronic, magnetic, optical, electromagnetic, infrared, or semiconductor systems, devices or devices, or any suitable combination of the above. More specific examples of the machine-readable storage media can include an electrical connection based on one or more wires, a portable computer disk, a hard disk, a random access memory (RAM), read-only memory (ROM), an erasable programmable read-only memory (EPROM), a flash memory: an optical fiber, a compact disk read-only memory (CD-ROM), an optical storage device, a magnetic storage device, or any suitable combination of the above.

In a first example of the first aspect, a product display method is provided in the disclosure, which includes:
obtaining, in a first application, at least one product object information corresponding to at least one live room;
in response to a display policy being satisfied, displaying a second interface in a first interface of the first application, the second interface including information of the live room and the product object information;
in response to detecting a first trigger signal for the second interface, displaying a detailed information browsing interface corresponding to the product object information, and/or displaying a live room viewing interface, the livestreaming viewing interface including the product object information.

Based on the first example of the first aspect, in a second example of the first aspect, the satisfying the display policy includes at least one of the following: a number of terminating of the second interface being less than the first threshold, and a second trigger signal being received.

Based on the first example of the first aspect, in a third example of the first aspect, the at least one live room satisfies the at least one live room satisfies at least one of following conditions: a number of followers of a host of the live room being greater than or equal to a second threshold, the host of the live room being in a front position in a host sequence arranged in a descending order of numbers of followers, a historical sale parameter of the host of the live room being greater than or equal to a third threshold, and the host of the live room being in a front position in a host sequence ranked in a descending order of historical sale parameters.

Based on the first example of the first aspect, in a fourth example of the first aspect, the at least one product object information satisfies at least one of following conditions: a reference parameter corresponding to the product object information being greater than or equal to the first threshold, and the product object information being in a front position in a product object information sequence ranked in a descending order of reference parameters. The reference parameter includes at least one of the following: a historical sale parameter of the product object information and a historical search parameter for the product object information.

Based on the first example of the first aspect, in a fifth example of the first aspect, the method further includes:
ceasing displaying the second interface in the first interface of the first application in response to satisfying a stop display policy when the second interface is displayed in the first interface of the first application.

Based on the fifth example of the first aspect, in a sixth example of the first aspect, the satisfying the stop display policy comprises at least one of the following: receiving a terminating operation on the second interface, and sale of products corresponding to the at least one product object information being ended.

Based on the first example of the first aspect, in a seventh example of the first aspect, the product object information in the second interface is displayed in a switching way, product object information before switching is product object information of a product whose sale is ended, and product object information after switching is product object information of a product whose sale is not ended.

Based on the first example of the first aspect, in an eighth example of the first aspect, the method further includes:
displaying a third interface in the first interface of the first application, the third interface being a sub-interface of the first interface, and the third interface comprising at least one discounted product object information and at least one other product object information, which are alternately arranged.

Based on the first to eighth examples of the first aspect, in a ninth example of the first aspect, the product object information further comprises discount information of a product.

Based on the first to eighth examples of the first aspect, in a tenth example of the first aspect, the product object information further comprises a sale progress of a product, when a sold parameter of a product is greater than or equal to a fourth threshold and less than the fifth threshold, the sale progress is the sold parameter; and when the sold parameter of the product is greater than or equal to a fifth threshold, the sale progress is an unsold parameter.

Based on the first to eighth examples of the first aspect, in an eleventh example of the first aspect, the product object information further comprises a recommendation reason or information of a host corresponding to the product object information, and the recommendation reason comprises at least one of the following: having purchased other products of a target host, and following the target host, the target host being a host to which a product corresponding to the product object information belongs.

Based on the first to eighth examples of the first aspect, in a twelfth example of the first aspect, the product object information includes an image and text, and the text is superimposed and displayed on the image.

In a first example of the second aspect, a product display apparatus is provided, which includes:
a product object information acquisition module configured for obtaining product object information corresponding to at least one live room in a first application;
a first display module configured for, in response to satisfying a display policy, displaying a second interface in a first interface of the first application, the second interface including information of the live room and the product object information; and
a second display module configured for, in response to detecting a first trigger signal for the second interface, displaying a detailed information browsing interface corresponding to the product object information, and/or displaying a live room viewing interface, the livestreaming viewing interface including the product object information.

Based on the first example of the second aspect, in a second example of the second aspect, the satisfying the display policy includes at least one of the following: a number of terminating of the second interface being less than the first threshold, and a second trigger signal being received.

Based on the first example of the second aspect, in a third example of the second aspect, the at least one live room satisfies the at least one live room satisfies at least one of following conditions: a number of followers of a host of the live room being greater than or equal to a second threshold, the host of the live room being in a front position in a host sequence arranged in a descending order of numbers of followers, a historical sale parameter of the host of the live room being greater than or equal to a third threshold, and the host of the live room being in a front position in a host sequence ranked in a descending order of historical sale parameters.

Based on the first example of the second aspect, in a fourth example of the second aspect, the at least one product object information satisfies at least one of following conditions: a reference parameter corresponding to the product object information being greater than or equal to the first threshold, and the product object information being in a front position in a product object information sequence ranked in a descending order of reference parameters. The reference parameter includes at least one of the following: a historical sale parameter of the product object information and a historical search parameter for the product object information.

Based on the first example of the second aspect, in a fifth example of the second aspect, the apparatus further includes:
a stop display module configured for ceasing displaying the second interface in the first interface of the first application in response to satisfying a stop display policy when the second interface is displayed in the first interface of the first application.

Based on the fifth example of the second aspect, in a sixth example of the second aspect, the satisfying the stop display policy comprises at least one of the following: receiving a terminating operation on the second interface, and sale of products corresponding to the at least one product object information being ended.

Based on the first example of the second aspect, in a seventh example of the second aspect, the product object information in the second interface is displayed in a switching way, product object information before switching is product object information of a product whose sale is ended, and product object information after switching is product object information of a product whose sale is not ended.

Based on the first example of the second aspect, in an eighth example of the second aspect, the apparatus further includes:
a third display module configured for displaying a third interface in the first interface of the first application, the third interface being a sub-interface of the first interface, and the third interface comprising at least one discounted product object information and at least one other product object information, which are alternately arranged.

Based on the first to eighth examples of the second aspect, in a ninth example of the second aspect, the product object information further comprises discount information of a product.

Based on the first to eighth examples of the second aspect, in a tenth example of the second aspect, the product object information further comprises a sale progress of a product, when a sold parameter of a product is greater than or equal to a fourth threshold and less than the fifth threshold, the sale progress is the sold parameter; and when the sold parameter of the product is greater than or equal to a fifth threshold, the sale progress is an unsold parameter.

Based on the first to eighth examples of the second aspect, in an eleventh example of the second aspect, the product object information further comprises a recommendation reason or information of a host corresponding to the product object information, and the recommendation reason comprises at least one of the following: having purchased other products of a target host, and following the target host, the target host being a host to which a product corresponding to the product object information belongs.

Based on the first to eighth examples of the second aspect, in a twelfth example of the second aspect, the product object information includes an image and text, and the text is superimposed and displayed on the image.

In a third aspect, an electronic device is provided according to one or more embodiments of the present disclosure, which includes: at least one processor and a memory.

The memory is configured for storing computer-executed instructions.

The at least one processor is configured for executing the computer-executed instructions stored in the memory, causing the electronic device to implement the method as described in the first aspect.

In a fourth aspect, a computer-readable storage medium is provided according to one or more embodiments of the present disclosure, with computer-executed instructions stored therein, which, when executed by a computing device, causes the computing device to implement the method as described in the first aspect.

In a fifth aspect, a computer program product is provided according to one or more embodiments of the present disclosure, which includes a computer program. The computer program is executed by a processor for implementing the method as described in the first aspect.

In a sixth aspect, a computer program is provided according to one or more embodiments of the present disclosure. The computer program is executed by a processor for implementing the method as described in the first aspect.

A product display method and device are provided in embodiments of the disclosure, and the method includes: obtaining, in a first application, at least one product object information corresponding to at least one live room: in response to a display policy being satisfied, displaying a second interface in a first interface of the first application, the second interface including information of the live room and the product object information; and in response to detecting a first trigger signal for the second interface, displaying a detailed information browsing interface corresponding to the product object information, and/or displaying a live room viewing interface, the livestreaming viewing interface including the product object information. In the embodiments of the disclosure, the second interface can be displayed in the first interface, the second interface includes the product object information in the live room, so that the user not being watching the livestreaming can purchase products in the live room through the second interface.

The above description is only preferred embodiments of the present disclosure and explanation of technical principles used. It should be understood by those skilled in the art that the scope involved in the present disclosure is not limited to technical schemes formed by a specific combination of the above technical features but should also cover other technical schemes formed by any combination of the above technical features or their equivalent features without departing from the above disclosed concept. For example, technical schemes formed by replacing the above features with (but not limited to) technical features with similar functions disclosed in the present disclosure are covered.

In addition, although the operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limitations on the scope of the present disclosure. Certain features described in the context of individual embodiments may also be implemented in combination in a single embodiment. Conversely, various features described in the context of a single embodiment may also be implemented in multiple embodiments individually or in any suitable subcombination.

Although the subject matter has been described in language specific to structural features and/or methodological logical acts, it should be understood that the subject matter defined in the appended claims is not necessarily limited to the particular features or acts described above. Rather, the particular features and acts described above are merely exemplary forms of implementation of the claims.

1. A product display method, comprising:
obtaining, in a first application, product information of at least one product corresponding to at least one live room;
in response to a display policy being satisfied, displaying a second interface in a first interface of the first application, the second interface including information of the live room and the product information;
in response to detecting a first trigger for the second interface, displaying an interface for presenting detailed information corresponding to the product information, and/or displaying an interface of a live room, the interface of the live room including the product information.

2. The method according to claim 1, wherein the display policy being satisfied comprises at least one of the following: a number that the second interface is terminated being less than a first threshold, and a second trigger being received.

3. The method according to claim 1, wherein the at least one live room satisfies at least one of following: a number of followers of a host of the live room being greater than or equal to a second threshold, the host of the live room being in one of top N1 positions in a host sequence ranked in a descending order of numbers of followers, a historical sale parameter of the host of the live room being greater than or equal to a third threshold, and the host of the live room being in one of top N2 positions in a host sequence ranked in a descending order of historical sale parameters.

4. The method according to claim 1, wherein the at least one product information satisfies at least one of following: a reference parameter corresponding to the product information being greater than or equal to the first threshold, and the product information being in one of top N3 positions in a product information sequence ranked in a descending order of reference parameters.

5. The method according to claim 1, further comprising:
if the second interface is displayed in the first interface of the first application, ceasing displaying the second interface in the first interface of the first application in response to a corresponding policy being satisfied.

6. The method according to claim 5, wherein the corresponding policy be satisfied comprises at least one of the following: receiving a terminating operation on the second interface, and sale of products corresponding to the at least one product information being ended.

7. The method according to claim 1, wherein the product information in the second interface is displayed in a switching way, product information before switching comprise product information of a product sale of which is ended, and product information after switching comprise product information of a product sale of which is not ended.

8. The method according to claim 1, further comprising:
displaying a third interface in the first interface of the first application, the third interface being a sub-interface of the first interface, and the third interface comprising first information of at least one discounted product and second information at least one other product, wherein the first information and the second information are alternately arranged in the third interface.

9. The method according to claim 1, wherein the product information further comprises discount information of a product.

10. The method according to claim 1, wherein the product information further indicates a sale progress of a product, when a sold parameter of a product is greater than or equal to a fourth threshold and less than the fifth threshold, the sale progress is corresponding to the sold parameter; and when the sold parameter of the product is greater than or equal to a fifth threshold, the sale progress is corresponding to an unsold parameter.

11. The method according to claim 1, wherein the product information further indicates a recommendation reason or information of a host corresponding to the product information, and the recommendation reason comprises, following the target host, the target host being a host to which a product corresponding to the product information belongs.

12. The method according to claim 1, wherein the product information comprises an image and a text, the text being superimposed on the image.

13. (canceled)

14. An electronic device, comprising: at least one processor and a memory; wherein
the memory is configured for storing computer-executed instructions; and
the at least one processor is configured for executing the computer-executed instructions stored in the memory, causing the electronic device to implement a method comprising:
obtaining, in a first application, product information of at least one product corresponding to at least one live room;
in response to a display policy being satisfied, displaying a second interface in a first interface of the first application, the second interface including information of the live room and the product information;
in response to detecting a first trigger for the second interface, displaying an interface for presenting detailed information corresponding to the product information, and/or displaying an interface of a live room, the interface of the live room including the product information.

15. A non-transitory computer-readable storage medium, having computer-executed instructions stored therein, which, when executed by a computing device, causes the computing device to implement a method comprising:
obtaining, in a first application, product information of at least one product corresponding to at least one live room;
in response to a display policy being satisfied, displaying a second interface in a first interface of the first application, the second interface including information of the live room and the product information;
in response to detecting a first trigger for the second interface, displaying an interface for presenting detailed information corresponding to the product information, and/or displaying an interface of a live room, the interface of the live room including the product information.

16. (canceled)

17. (canceled)
